(19) United States
(12) Patent Application Publication
(10) Pub. No.: US 2019/0292069 A1
(43) Pub. Date: Sep. 26, 2019

(54) FILTERED PITCHER AND DRINKING VESSEL

(71) Applicant: Nancie Weston, Camano Island, WA (US)

(72) Inventor: Nancie Weston, Camano Island, WA (US)

(21) Appl. No.: 16/359,283

(22) Filed: Mar. 20, 2019

Related U.S. Application Data
(60) Provisional application No. 62/646,283, filed on Mar. 21, 2018.

(51) Int. Cl. C02F 1/00; C02F 1/68; C02F 1/48

(52) U.S. Cl. CPC C02F 1/003; C02F 1/68; C02F 2307/04; C02F 2303/04; C02F 1/48

(57) ABSTRACT

A vessel that has a pre-filtered liquid area, a compressible portion, and filter material. The pre-filtered liquid area is configured to receive an unfiltered liquid. The compressible portion defines at least in part a filtered liquid storage area. The compressible portion is configured to be compressed into a compressed state and to return to an uncompressed state when no longer compressed. The filter material is positioned between the pre-filtered liquid area and the filtered liquid storage area. The unfiltered liquid is sucked from the pre-filtered liquid area through the filter material and into the filtered liquid storage area when the compressible portion returns to the uncompressed state. The filter material filters the unfiltered liquid, as the unfiltered liquid is sucked through the filter material, to produce a processed liquid that includes filtered liquid and/or purified liquid.

### CROSS REFERENCE TO RELATED APPLICATION(S)

This application claims the benefit of U.S. Provisional Application No. 62/646,283, filed on Mar. 21, 2018, which is incorporated herein by reference in its entirety.

### BACKGROUND OF THE INVENTION

### Field of the Invention

The present invention is directed generally to filtering and/or purifying pitchers as well as to filtering and/or purifying drinking vessels.

### Description of the Related Art

Many consumers like to drink filtered and/or purified liquids, such as water. Unfortunately, filtering and/or purifying liquids typically requires that gravity pull the liquids downwardly through a filter or purifier, which can be a time consuming process. Alternatively, a consumer may suck liquids (e.g., contaminated water) upwardly through a filter or purifier by applying suction with the consumer's mouth to a straw-like mouth piece. Unfortunately, this is typically a slow process that requires a significant amount of effort on the part of the consumer.

### BRIEF DESCRIPTION OF THE SEVERAL VIEWS OF THE DRAWINGS

FIG. 1 is a perspective view of a first embodiment of a pitcher.

FIG. 2 is an exploded view of the pitcher of FIG. 1 illustrated with its body portion as being transparent and its compressible portion(s) as being opaque.

FIG. 3 is a perspective sectional view of the pitcher of FIG. 1 illustrated filtering water.

FIG. 4 is a perspective view of the pitcher of FIG. 1 with its lid positioned in an open position and its body portion as being transparent.

FIG. 5 is a perspective partial sectional view of the pitcher of FIG. 1 illustrated with both its lid and filter holder positioned in open positions and its body portion as being transparent.

FIG. 6 is a perspective view of the pitcher of FIG. 1 with its spout closure positioned in an open position and its body portion as being transparent.

FIG. 7 is a top view into the pitcher of FIG. 1 with its spout closure and lid omitted.

FIG. 8 is a top view into the pitcher of FIG. 1 with its spout closure, lid, and filter holder omitted.

FIG. 9 is a perspective view of the body portion of the pitcher of FIG. 1.

FIG. 10 is a top perspective view of a pre-filtered liquid area of the pitcher of FIG. 1.

FIG. 11 is an upper side perspective view of the pre-filtered liquid area of the pitcher of FIG. 1.

FIG. 12 is an exploded perspective view of an internal housing and an optional seal of the pitcher of FIG. 1.

FIG. 13 is a top perspective view of a flap of the pitcher of FIG. 1.

FIG. 14 is a bottom perspective view of the flap of the pitcher of FIG. 1.

FIG. 15 is a top perspective view of a filter member of the pitcher of FIG. 1.

FIG. 16 is an exploded perspective view of an optional seal and filter material(s) of the filter member of FIG. 15.

FIG. 17 is an exploded perspective view of a peripheral frame and a central portion of a filter holder of the pitcher of FIG. 1.

FIG. 18 is a bottom perspective view of the filter holder of the pitcher of FIG. 1.

FIG. 19 is a bottom perspective view of the lid of the pitcher of FIG. 1.

FIG. 20 is a top perspective view of the spout closure of the pitcher of FIG. 1.

FIG. 21 is a bottom perspective view of the spout closure of the pitcher of FIG. 1.

FIG. 22 is a perspective view of the pitcher of FIG. 1 illustrated with its compressible portion(s) in a compressed state and its body portion illustrated as being transparent.

FIG. 23 is a side view of a second embodiment of a pitcher that includes a single compressible portion and is illustrated with its body portion shown as being transparent.

FIG. 24 is a perspective view of the pitcher of FIG. 23 with its body portion illustrated as being transparent.

FIG. 25 is a perspective view of a drinking vessel that includes a compressible body portion, an outer housing, an inner housing, a filter member, and a lid, which is illustrated in an open position.

FIG. 26 is a perspective view of the drinking vessel of FIG. 25 illustrated with a drinking cover of the lid in an open position.

FIG. 27 is a perspective sectional view of the drinking vessel of FIG. 25 illustrated filtering water and with a storage cover of the lid in an open position.

FIG. 28 is a front view of the drinking vessel of FIG. 25 illustrated with its compressible body portion in a compressed state and its storage cover in the open position.

FIG. 29 is a perspective partial sectional view of the outer housing and the compressible body portion of the drinking vessel of FIG. 25.

FIG. 30 is a perspective partial sectional view of the filter member, the outer housing, and the compressible body portion of the drinking vessel of FIG. 25.

FIG. 31 is a perspective sectional view of the inner housing of the drinking vessel of FIG. 25.

FIG. 32 is a top perspective view of the filter member of the drinking vessel of FIG. 25.

FIG. 33 is a bottom perspective view of the filter member of the drinking vessel of FIG. 25.

FIG. 34 is a perspective partial sectional view of the drinking vessel of FIG. 25.

Like reference numerals have been used in the figures to identify like components.

### DETAILED DESCRIPTION OF THE INVENTION

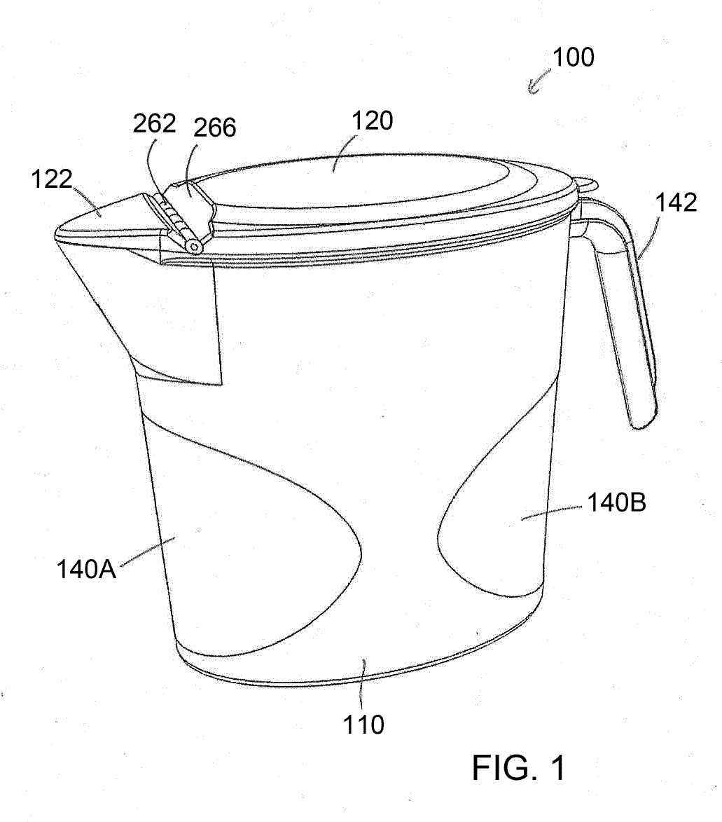

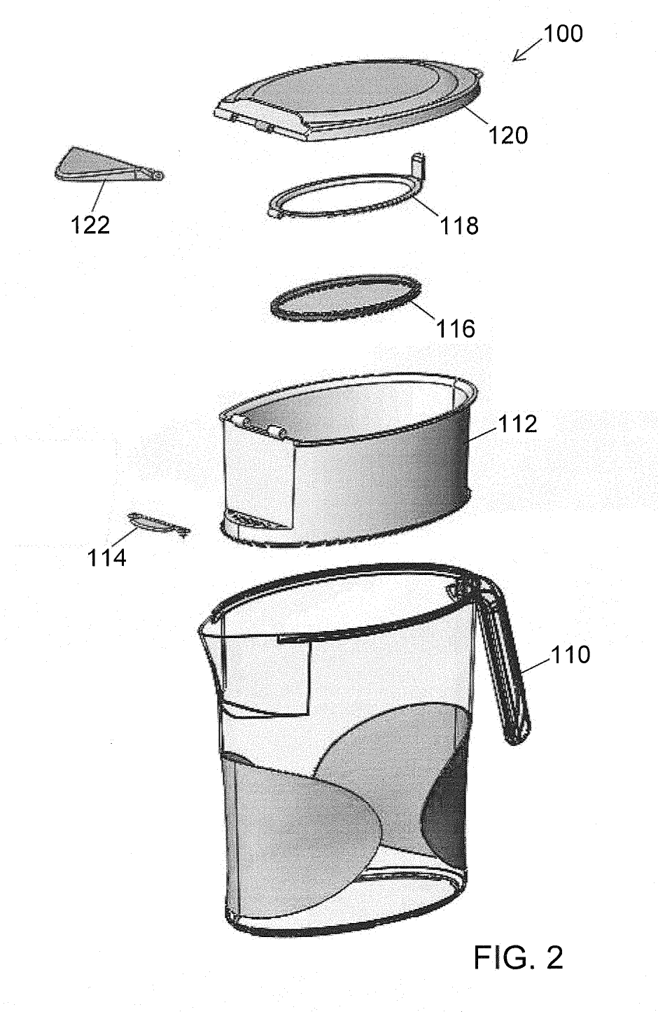

FIG. 1 is a perspective view of a pitcher 100 and FIG. 2 is an exploded view of the pitcher 100. Referring to FIG. 2, the pitcher 100 includes a body portion 110, an internal housing 112, a flap 114, a filter member 116, a filter holder 118, a lid 120, and a spout closure 122.

### Body Portion

Referring to FIG. 9, the body portion 110 includes a lower closed portion 130 opposite an upper open portion 132. A sidewall 133 extends between the lower closed portion 130 and the upper open portion 132. A spout 134 is formed an upper portion of the sidewall 133 and is open along the upper open portion 132. The sidewall 133 and the lower closed portion 130 define a hollow interior 136 in fluid communication with the spout 134. A shoulder 138 extends around at least a portion of the upper open portion 132 and is positioned inside the hollow interior 136.

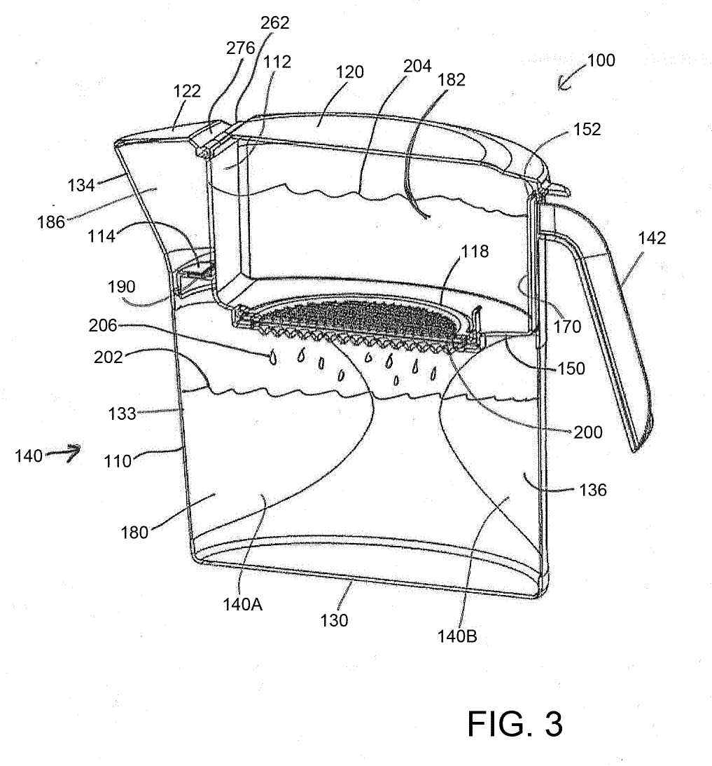

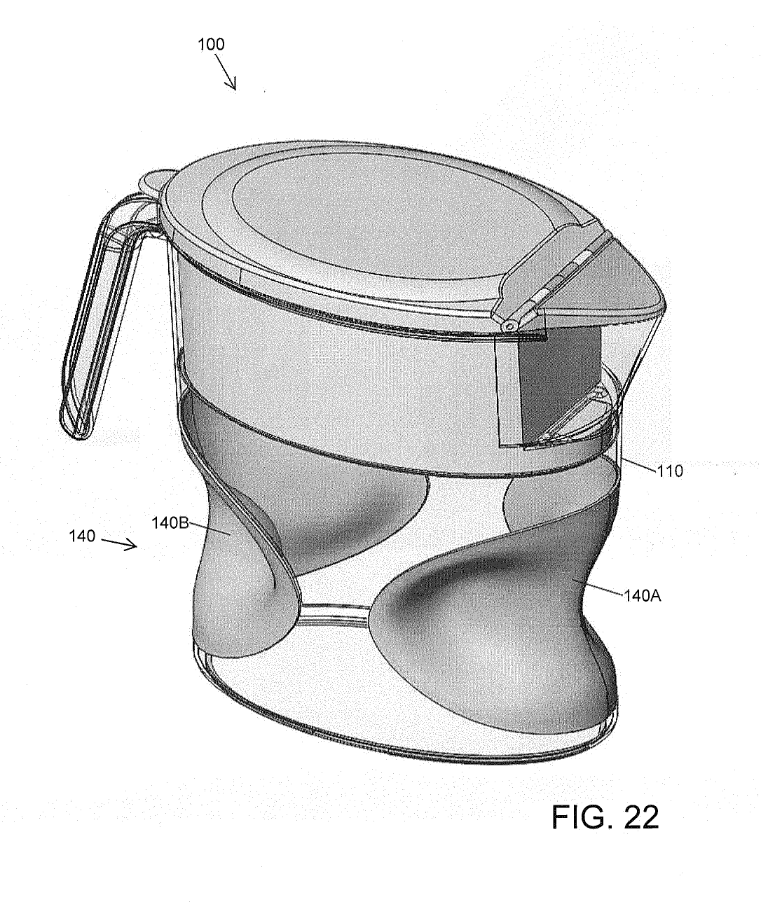

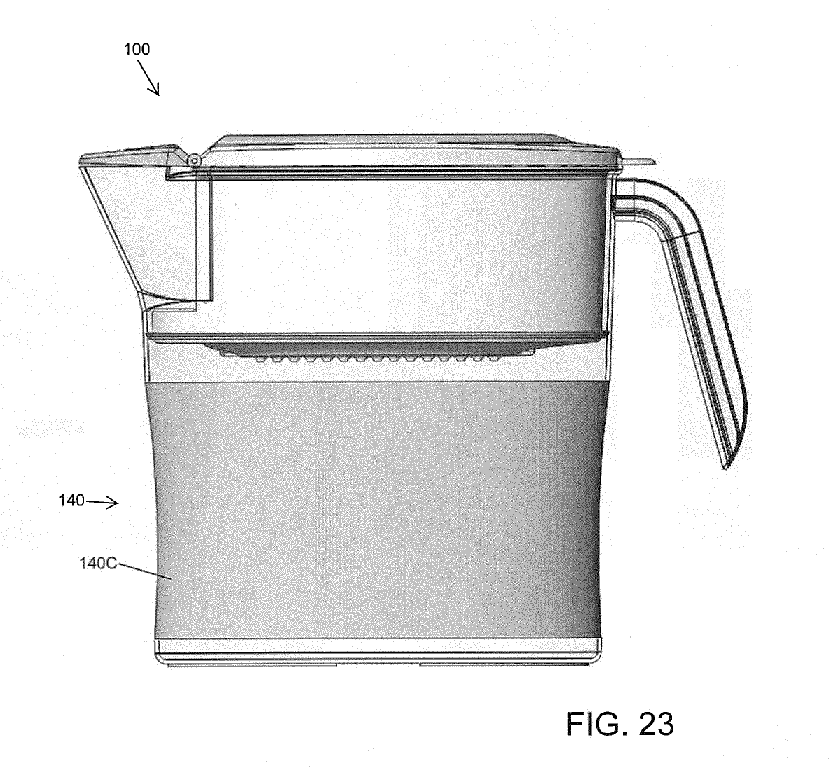

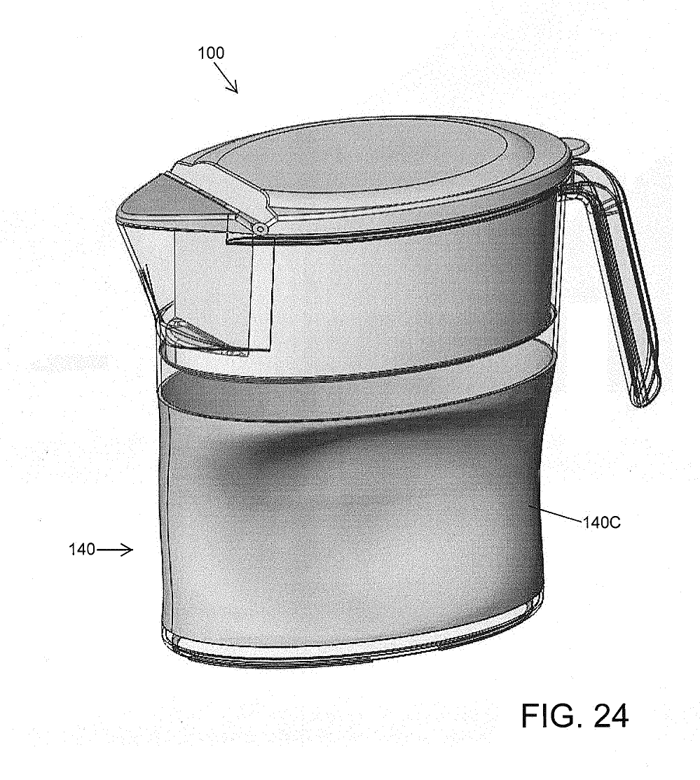

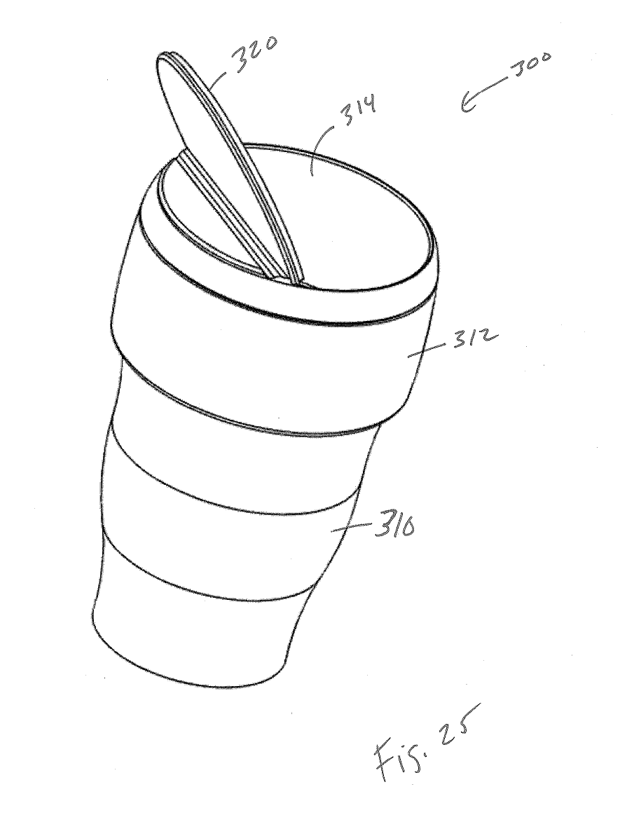

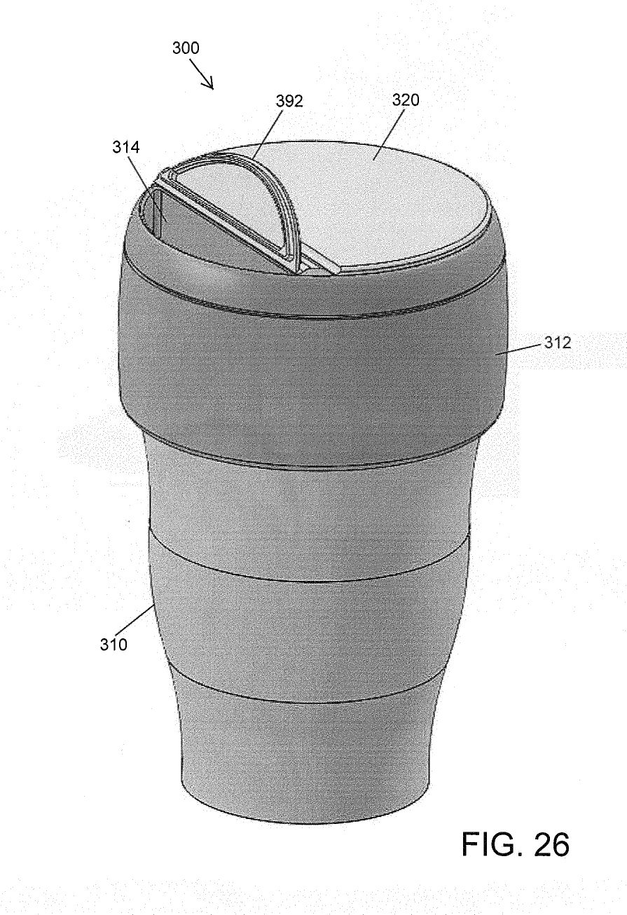

The body portion 110 includes one or more compressible portions 140. In the embodiment illustrated, the compressible portion(s) 140 include compressible portions 140A and 140B. In an alternate embodiment illustrated in FIGS. 23 and 24, the compressible portion(s) 140 include a single compressible portion 140C. Each of the compressible portion(s) 140 may be transitioned between an uncompressed state (see FIGS. 1-6) and a compressed state (see FIG. 22). The compressible portion(s) 140 is/are configured to be compressed manually by a user to transition the compressible portion(s) 140 from the uncompressed state to the compressed state. Referring to FIG. 3, in the compressed state, the compressible portion(s) 140 reduce a volume of the hollow interior 136. By way of a non-limiting example, FIG. 22 illustrates the compressible portions 140A and 140B in the compressed state. By way of another non-limiting example, FIG. 24 illustrates the compressible portion 140C in the compressed state. Referring to FIG. 3, reducing the volume forces air from inside the hollow interior 136 out through the upper open portion 132. By way of a non-limiting example, the compressible portion(s) 140 may be constructed from silicone or similar deformable material.

Optionally, the body portion 110 may include a handle 142 opposite the spout 134. The handle 142 is configured to be lifted by the user and used to tip the spout 134 downwardly.

### Internal Housing

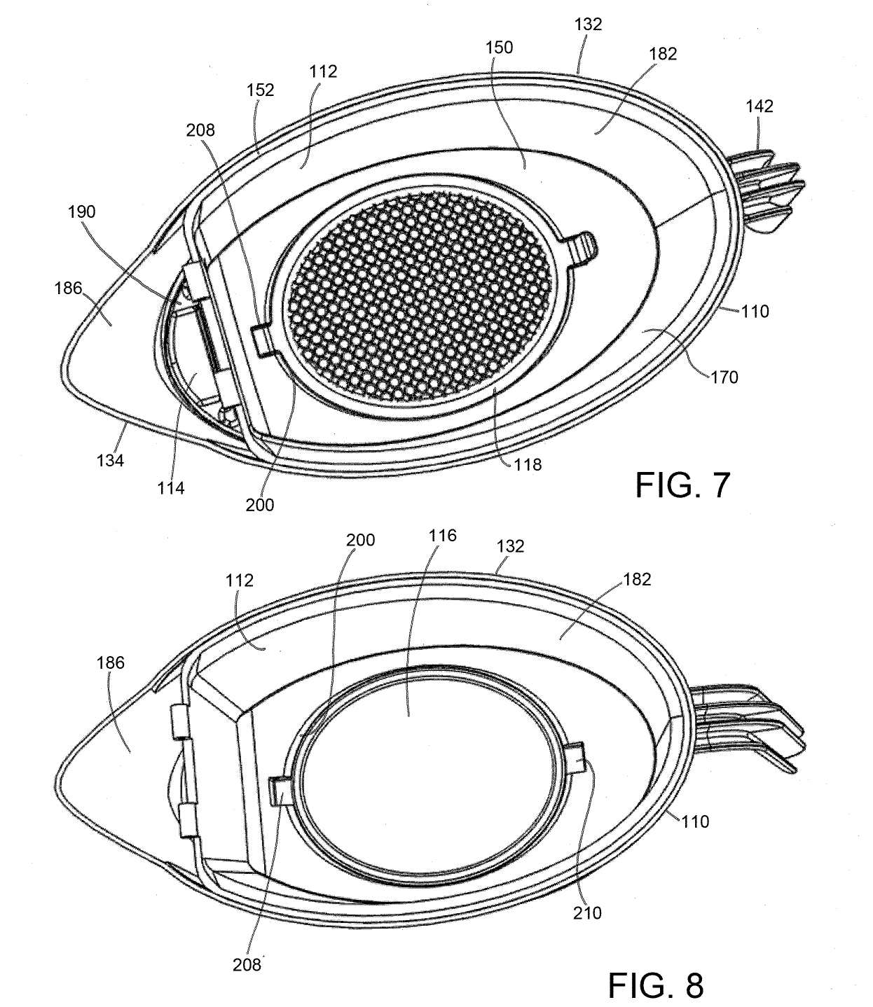

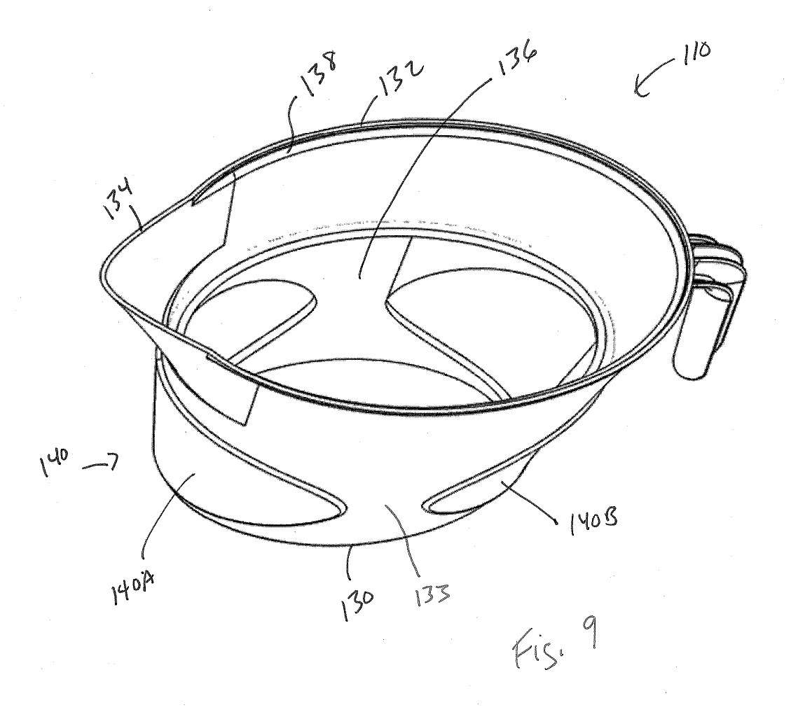

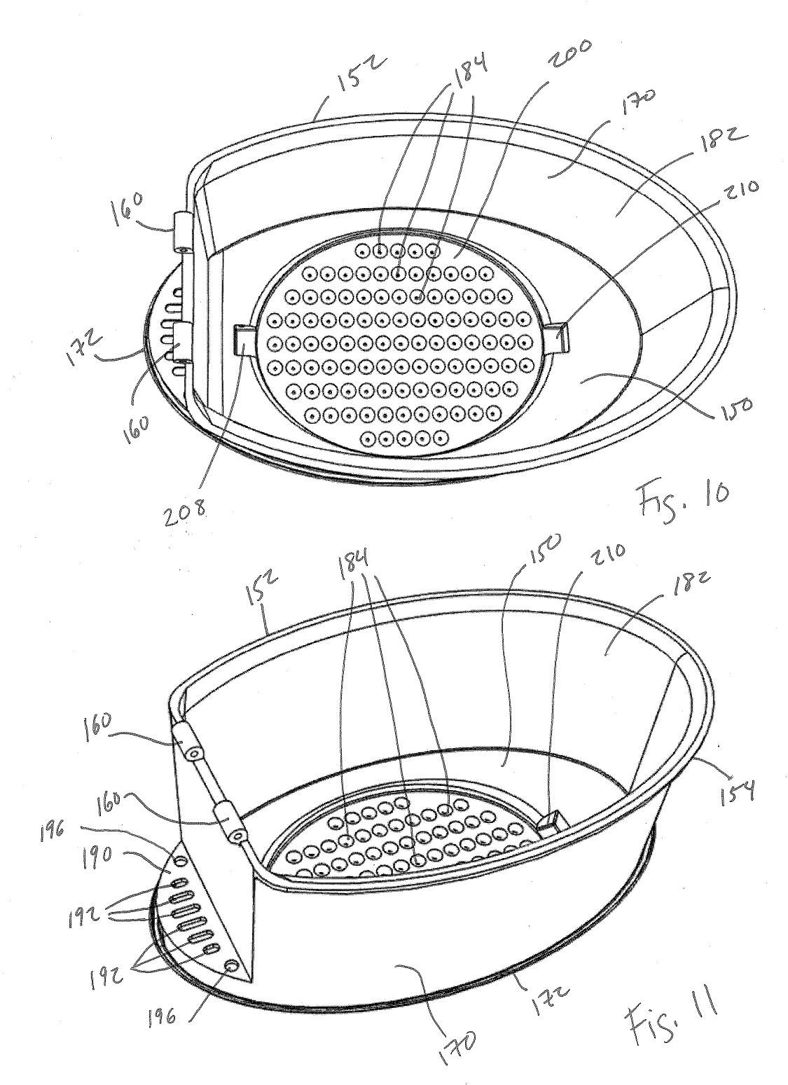

Referring to FIG. 7, the internal housing 112 is configured to be received inside the upper open portion 132. The internal housing 112 includes a lower closed portion 150 opposite an upper open portion 152. Referring to FIG. 11, an overhang portion 154 extends outwardly from at least a portion of the upper open portion 152. The overhang portion 154 is configured to rest upon the shoulder 138 (see FIG. 9) of the body portion 110. Referring to FIG. 3, the lower closed portion 150 is configured to be positioned inside the hollow interior 136 of the body portion 110. Referring to FIGS. 10 and 11, the upper open portion 152 includes one or more hinge portions 160 that extend upwardly and are positioned outside the hollow interior 136 (see FIGS. 3, 5, and 9) of the body portion 110 (see FIGS. 1-9 and 22).

The internal housing 112 has a sidewall 170 that extends between the lower closed portion 150 and the upper open portion 152. The hinge portion(s) 160 each extend upwardly from the sidewall 170. An optional seal 172 may extend around an outside surface of a lower portion of the sidewall 170 along or near the lower closed portion 150.

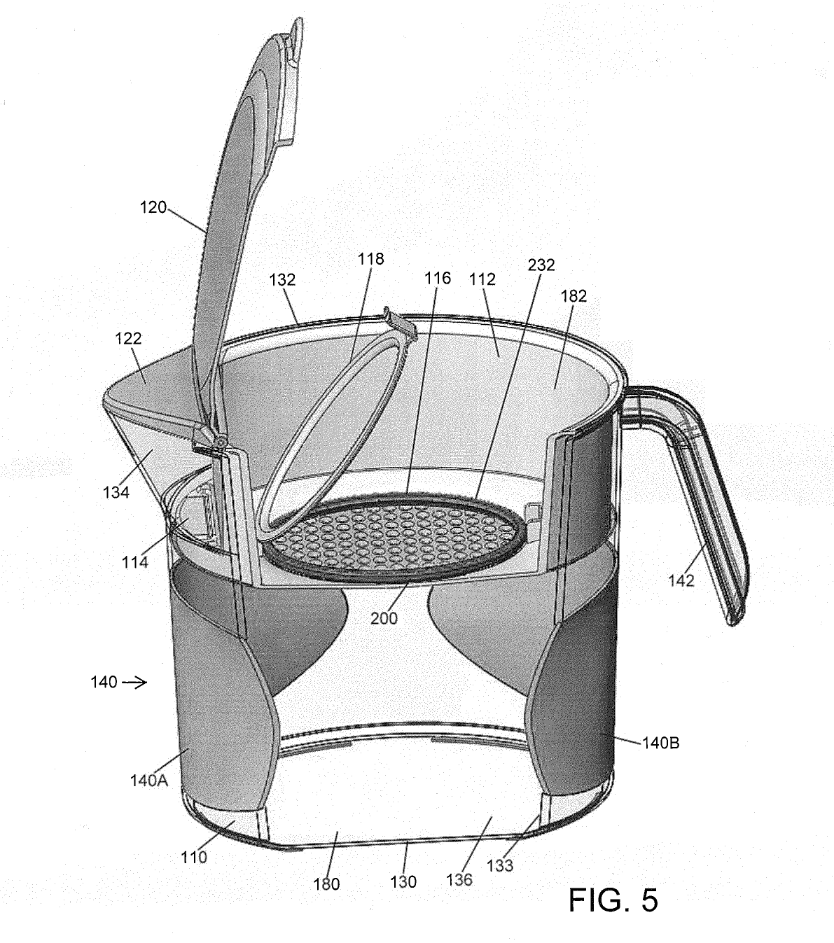

Referring to FIG. 3, the lower closed portion 150, the sidewall 170, and the optional seal 172 (see FIGS. 10-12) divide the hollow interior 136 into a filtered liquid storage area 180, a pre-filtered liquid area 182, and a spout area 186. While identified as being the spout area 186, the spout area 186 may be characterized as being a pouring area because a filtered liquid 206 exits the pitcher 100 by being poured through the spout area 186. Referring to FIGS. 10-12, the lower closed portion 150 includes one or more through-holes 184 that interconnect the filtered liquid storage area 180 (see FIGS. 3 and 5) and the pre-filtered liquid area 182 (see FIGS. 3-5, 7, 8, 10, and 11). Referring to FIG. 3, the filtered liquid storage area 180 extends from the lower closed portion 130 of the body portion 110 to the lower closed portion 150 of the internal housing 112. By way of a non-limiting example, the filtered liquid storage area 180 may have a volume of about 10 cups. The pre-filtered liquid area 182 is defined by the sidewall 170 and extends from the upper open portion 152 to the lower closed portion 150. The spout area 186 is defined by the spout 134 and the sidewall 170. The spout area 186 extends from the upper open portion 152 to a spout portion 190 of the lower closed portion 150. The spout portion 190 extends outwardly from the sidewall 170 and is configured to divide the spout area 186 from the filtered liquid storage area 180. Referring to FIG. 11, the spout portion 190 includes one or more through-holes 192 that interconnect the spout area 186 (see FIGS. 3 and 6-8) with the filtered liquid storage area 180 (see FIGS. 3 and 5). The spout portion 190 may also include one or more apertures 196.

Referring to FIG. 10, inside the pre-filtered liquid area 182, the lower closed portion 150 includes a filter area 200. Referring to FIG. 8, the filter member 116 is configured to be positioned inside the filter area 200. Referring to FIG. 10, the through-hole(s) 184 is/are formed in the filter area 200. Referring to FIG. 3, the filter member 116 (see FIGS. 2, 5, 8, 15, and 16) filters a liquid 202 (e.g., water) as it flows from the pre-filtered liquid area 182 through the through-hole(s) 184 (see FIGS. 10-12) and into the filtered liquid storage area 180. Before the liquid 202 flows through the filter member 116 (see FIGS. 2, 5, 8, 15, and 16), the liquid 202 is an unfiltered liquid 204. After the liquid 202 flows through the filter member 116 (see FIGS. 2, 5, 8, 15, and 16), the liquid 202 is the filtered liquid 206.

Referring to FIG. 7, inside the pre-filtered liquid area 182 and alongside the filter area 200, the lower closed portion 150 may include a first recess 208 for a hinge or pivot pin (not shown) to which the filter holder 118 may be hingedly coupled. Referring to FIG. 8, the lower closed portion 150 may include a second recess 210 positioned alongside the filter area 200. In the embodiment illustrated, the second recess 210 is positioned opposite the first recess 208 across the filter area 200.

As shown in FIG. 3, the filter area 200 does not extend downward into the filtered liquid storage area 180.

### Flap

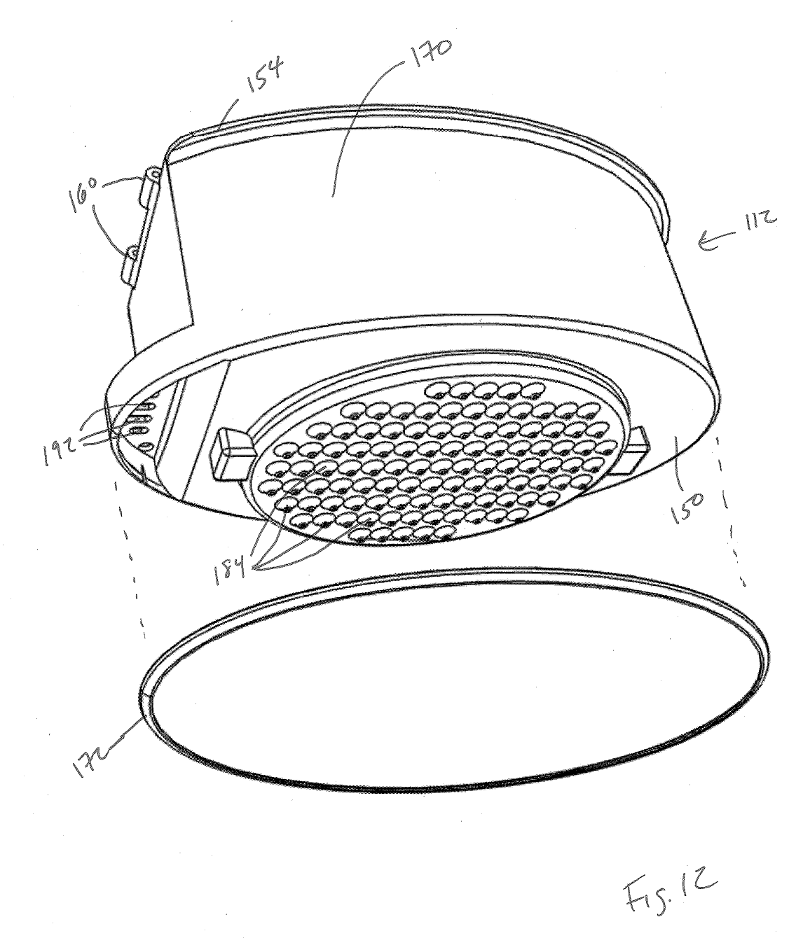

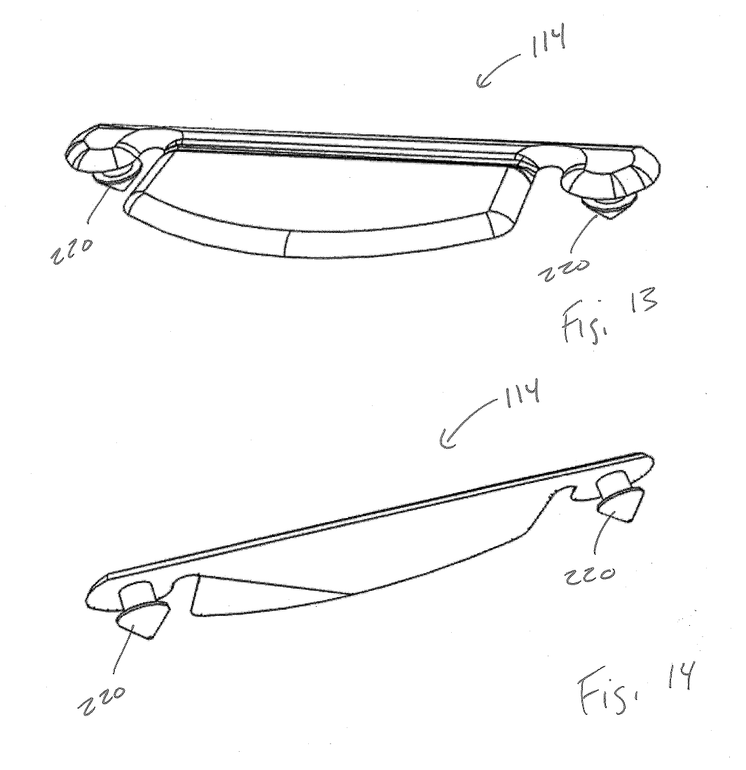

Referring to FIG. 3, the flap 114 is configured to cover the through-hole(s) 192 (see FIGS. 11 and 12) and prevent air from flowing into the filtered liquid storage area 180 through the through-hole(s) 192. Referring to FIGS. 13 and 14, in the embodiment illustrated, the flap 114 includes one or more gripping projections 220 each configured to be received inside one of the aperture(s) 196 (see FIG. 11) formed in the spout portion 190. The gripping projection(s) 220 help maintain the flap 114 in position on the spout portion 190. By way of a non-limiting example, the flap 114 may be constructed from silicone or similar deformable material.

### Filter Member

Referring to FIG. 5, the filter member 116 is configured to be positioned in the filter area 200 and to be maintained inside the filter area 200 by the filter holder 118. In the embodiment illustrated, the filter member 116 is generally disk shaped. However, this is not a requirement.

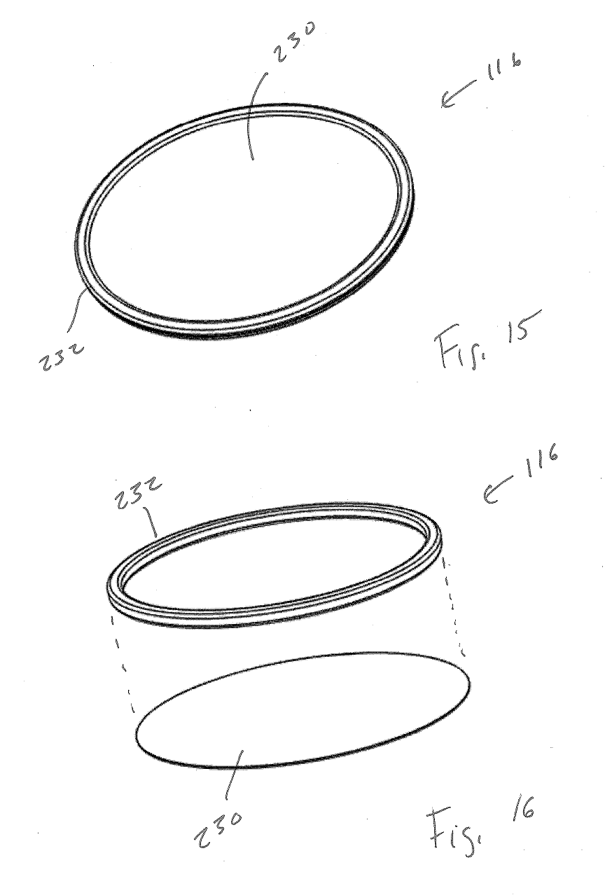

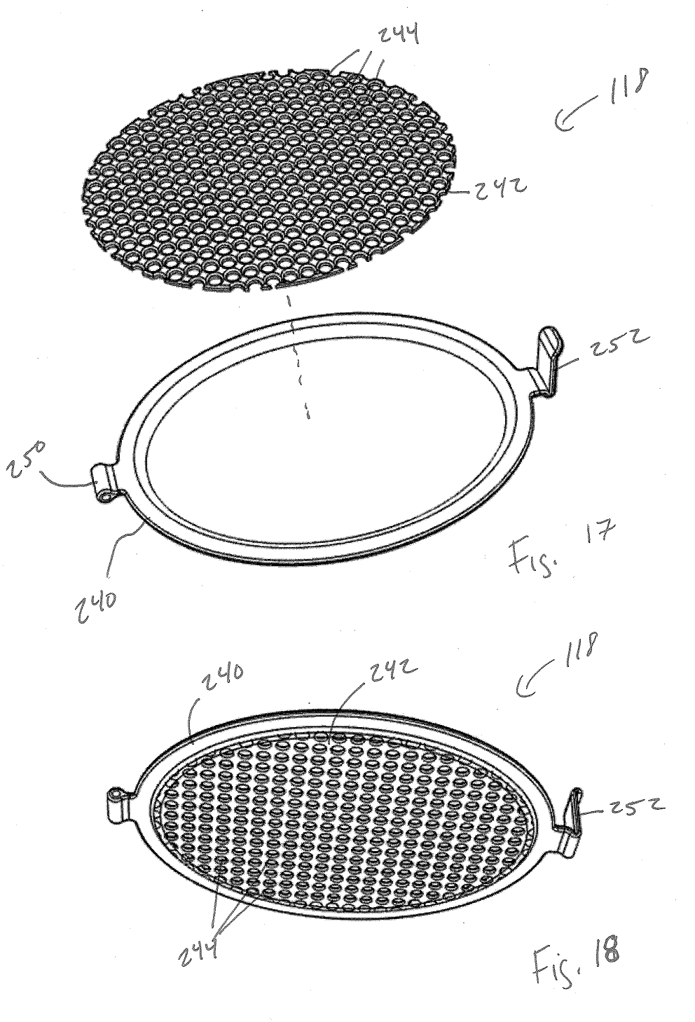

Referring to FIGS. 15 and 16, the filter member 116 includes one or more filter materials 230. The filter material(s) 230 may include one or more layers of different materials. The filter material(s) 230 may include a layer of any type of media that changes one or more characteristics of the unfiltered liquid 204. For example, a layer of the filter material(s) 230 may add flavor, remove particulates, purify the unfiltered liquid 204, and the like. By way of a non-limiting example, the filter material(s) 230 may be configured to add a flavoring to the filtered liquid 206 (see FIG. 3). The filter material(s) 230 may be configured to filter (e.g., using an electropositive charge, electro-adsorption, and the like) particulates (e.g., submicron particulates), pathogens, pharmaceuticals, and/or other debris from the liquid 202 (see FIG. 3). The filter material(s) 230 may be configured to filter alkalinity from or neutralize alkalinity in the liquid 202 (see FIG. 3).

Referring to FIGS. 15 and 16, the filter member 116 may include an optional seal 232 positioned about a periphery of the filter material(s) 230. The seal 232 may be configured to prevent the unfiltered liquid 204 (see FIG. 3) from flowing around (instead of through) the filter material(s) 230. By way of a non-limiting example, the seal 232 may be constructed from silicone or similar deformable material. Referring to FIG. 5, the seal 232 is configured to be compressed by the filter holder 118 against the filter area 200 of the lower closed portion 150 of the internal housing 112.

In alternate embodiments, the filter member 116 may omit the seal 232. In such embodiments, the filter holder 118 may include an upper seal (not shown) configured to abut the periphery of the filter member 116 along an upward facing side of the filter member 116 when the filter holder 118 is in the closed position. The upper seal (not shown) may help prevent the unfiltered liquid 204 (see FIG. 3) from flowing around (instead of through) the filter material(s) 230. Similarly, the filter area 200 may include a lower seal (not shown) configured to abut the periphery of the filter member 116 along a downward facing side of the filter member 116. The lower seal (not shown) may help prevent the unfiltered liquid 204 (see FIG. 3) from flowing around (instead of through) the filter material(s) 230.

### Filter Holder

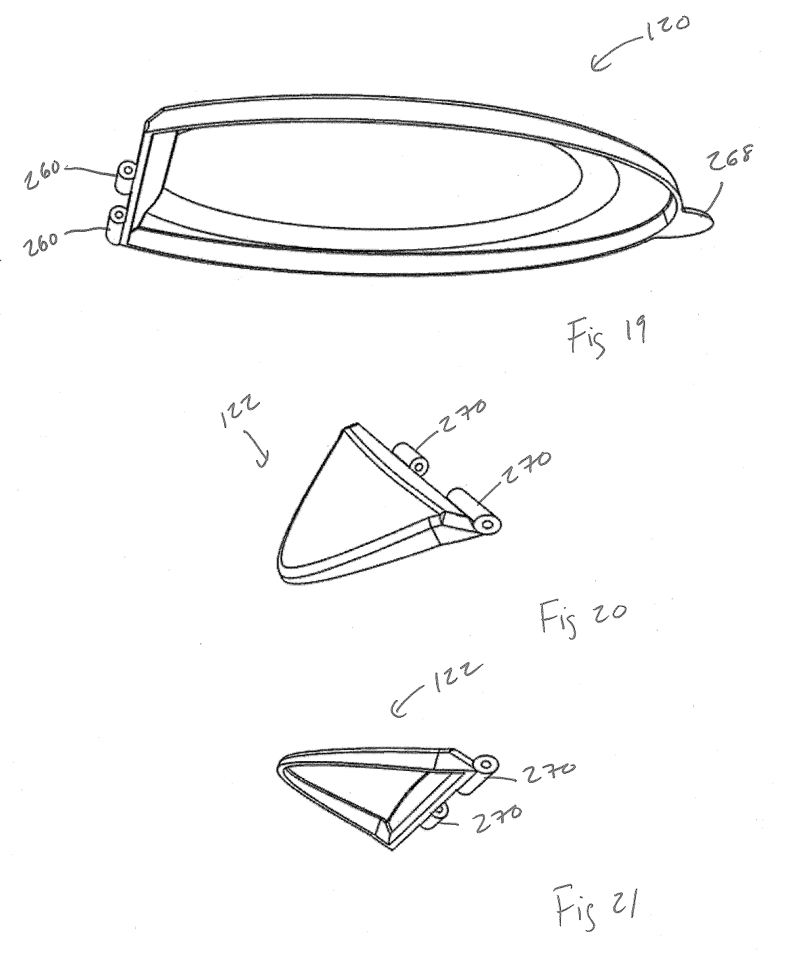

The filter holder 118 is configured to trap the filter member 116 inside the filter area 200 when the filter holder 118 is in a closed position (see FIGS. 3, 4, and 7). Referring to FIGS. 17 and 18, the filter holder 118 may include a peripheral frame 240. Optionally, the peripheral frame 240 may surround a central portion 242 that includes one or more through-holes 244. The unfiltered liquid 204 (see FIG. 3) flows through the filter holder 118 (e.g., through the through-hole(s) 244) and into the filter member 116 (see FIGS. 2, 5, 8, 15, and 16).

A hinge portion 250 may be attached to the peripheral frame 240. The hinge portion 250 is configured to be positioned inside the first recess 208 (see FIGS. 7, 8, and 10) and to engage the hinge or pivot pin (not shown). The hinge portion 250 is rotatable in the first recess 208 (see FIGS. 7, 8, and 10) about the hinge or pivot pin (not shown) into an open position (see FIG. 5). The filter member 116 (see FIGS. 2, 5, 8, 15, and 16) may be inserted into or removed from the filter area 200 when the filter holder 118 is in the open position (see FIG. 5). Thus, the filter member 116 (see FIGS. 2, 5, 8, 15, and 16) may be replaced so that the pitcher 100 may continue to be used.

Opposite the hinge portion 250, a spring latch portion 252 may be attached to the peripheral frame 240. The spring latch portion 252 is configured to be received inside the second recess 210 positioned alongside the filter area 200. The spring latch portion 252 helps maintain the filter holder 118 in the closed position (see FIGS. 3, 4, and 7).

### Lid

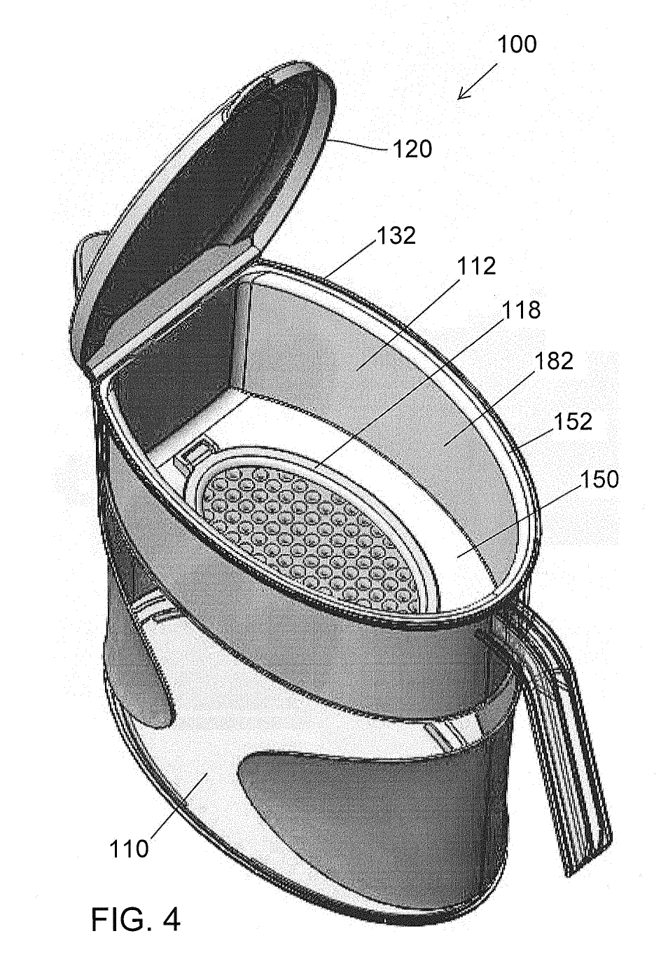

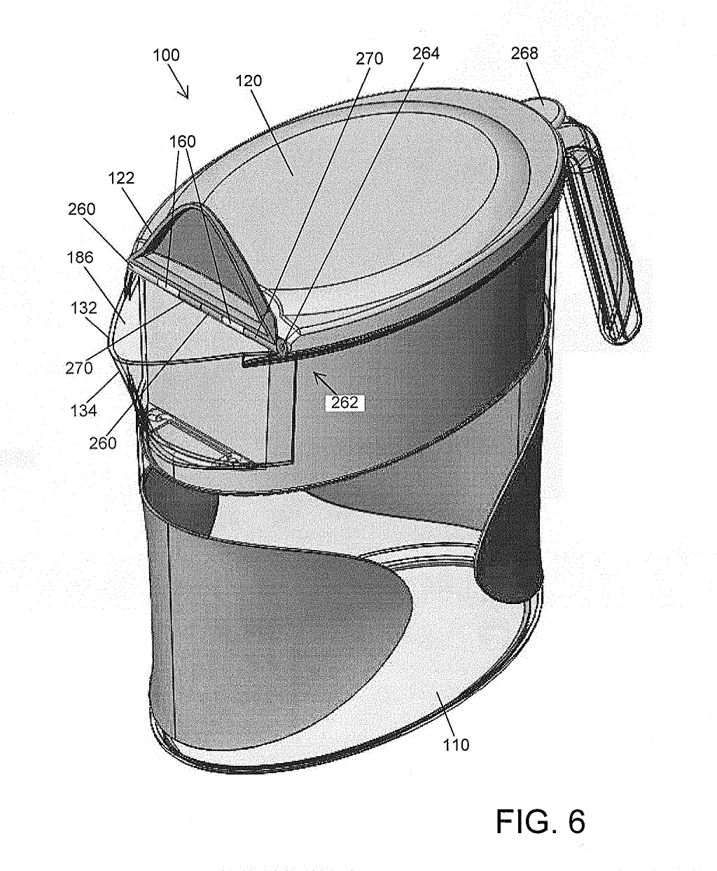

Referring to FIG. 4, the lid 120 is configured to cover the upper open portion 152 of the internal housing 112 when the lid 120 is in a closed position (see FIGS. 1, 3, and 6). Referring to FIG. 6, in the embodiment illustrated, the lid 120 includes hinge portion(s) 260 configured to be hingedly attached to the hinge portion(s) 160 of the upper open portion 152 (see FIGS. 3, 4, 7, 10, and 11) of the internal housing 112 (see FIGS. 2-5, 7, 8, and 10-12). The lid 120 may be removed or pivoted about a hinge 262 formed by a pivot pin 264 inserted into the aligned hinge portion(s) 160 and 260 into an open position (see FIGS. 4 and 5). Referring to FIG. 1, the lid 120 may include a sloped surface 266 that extends upwardly away from the hinge 262.

Referring to FIG. 4, when the lid 120 is in the closed position (see

FIGS. 1, 3, and 6), the lid 120 may seal the pre-filtered liquid area 182 along the upper open portion 152 of the internal housing 112 and prevent contaminants from the unfiltered liquid 204 (see FIG. 3) in the pre-filtered liquid area 182 from entering the spout area 186 (or post filtered/purified liquid area) because the lid 120 is forced closed and sealed. When the lid 120 is in the open position (see FIGS. 4 and 5), the lid 120 provides access to the pre-filtered liquid area 182 and allows the unfiltered liquid 204 (see FIG. 3) to enter the pre-filtered liquid area 182. Referring to FIG. 6, in the embodiment illustrated, the lid 120 includes a tab 268 configured to be used to rotate the lid 120 about the hinge 262. Referring to FIG. 3, optionally, a one-way valve (not shown) may be installed in the lid 120.

### Spout Closure

Referring to FIG. 6, the spout closure 122 is configured to cover the upper open portion 132 of the body portion 110 in the spout area 186 of the internal housing 112 when the spout closure 122 is in a closed position (see FIGS. 1 and 3-5). In the embodiment illustrated, the spout closure 122 includes hinge portion(s) 270 configured to be hingedly attached to the pivot pin 264 along with the hinge portion(s) 160 of the upper open portion 152 of the internal housing 112. Thus, the spout closure 122 may be pivoted about the hinge 262 in a manner similar as the lid 120. In other words, the spout closure 122 may be removed or pivoted about the hinge 262 into an open position (see FIG. 6). Referring to FIG. 1, the spout closure 122 may include a sloped surface 276 that extends upwardly away from the hinge 262.

Referring to FIG. 3, when the spout closure 122 is in the open position (see FIG. 6), the spout closure 122 allows the filtered liquid 206 to be poured from the filtered liquid storage area 180 through the through-hole(s) 192 (see FIGS. 11 and 12), and out the upper open portion 132 (see FIGS. 4, 5, and 7-9) in the spout area 186. On the other hand, referring to FIG. 6, when the spout closure 122 is in the closed position (see FIGS. 1 and 3-5), the spout closure 122 may seal the spout area 186 along the upper open portion 132 of the body portion 110 in the spout area 186 and prevent contaminants (e.g., the unfiltered liquid 204) from entering the spout area 186. Thus, if a person accidentally pours the unfiltered liquid 204 (see FIG. 3) on the spout closure 122, the unfiltered liquid 204 will not enter the spout area 186 preventing any cross-contamination. Referring to FIG. 3, the one-way valve (not shown) optionally installed in the lid 120 may be configured to allow air to flow into the filtered liquid storage area 180 (through the pre-filtered liquid area 182 and the through-hole(s) 184 illustrated in FIGS. 10-12) as the filtered liquid 206 is poured from the filtered liquid storage area 180 through the through-hole(s) 192 (see FIGS. 11 and 12), and out the upper open portion 132 (see FIGS. 4, 5, and 7-9) in the spout area 186.

The spout closure 122 may be configured to automatically transition the lid 120 from the open position (see FIGS. 4 and 5) to the closed position (see FIGS. 1, 3, and 6) when the spout closure 122 is rotated to the open position (see FIG. 6). For example, when the spout closure 122 is opened, the sloped surface 276 travels toward the sloped surface 266 of the lid 120. When the sloped surface 276 engages the sloped surface 266, the spout closure 122 rotates the lid 120 about the hinge 262 to the closed position. Similarly, the lid 120 may be configured to automatically transition the spout closure 122 from the open position (see FIG. 6) to the closed position (see FIGS. 1 and 3-5) when the lid 120 is rotated to the open position (see FIGS. 4 and 5). For example, when the lid 120 is opened, the sloped surface 266 travels toward the sloped surface 276 of the spout closure 122. When the sloped surface 266 engages the sloped surface 276, the lid 120 rotates the spout closure 122 about the hinge 262 to the closed position. Alternatively, the hinge 262 may be configured to force the lid 120 into the closed position when the spout closure 122 is rotated to the open position and to force the spout closure 122 into the closed position when the lid 120 is rotated to the open position. In such embodiments, only the lid 120 or the spout closure 122 may be open at one time, which prevents the unfiltered liquid 204 inside or being poured into the pre-filtered liquid area 182 (see FIGS. 3-5, 7, 8, 10, and 11) from contaminating the spout area 186 or the filtered liquid 206 via the spout closure 122. It also prevents the filtered liquid 206 (e.g., when the filtered liquid 206 is being poured from the filtered liquid storage area 180) from entering the pre-filtered liquid area 182 via the lid 120.

### Operation

Referring to FIG. 3, the user fills the pitcher 100 by compressing the compressible portion(s) 140 into the compressed state, which forces air from the filtered liquid storage area 180 out through the through-hole(s) 192 (see FIGS. 11 and 12) causing the flap 114 to rotate upwardly into the spout area 186.

When the user stops compressing the compressible portion(s) 140, air is no longer being forced through the through-hole(s) 192 (see FIGS. 11 and 12) causing the flap 114 to rotate downwardly and plug the through-hole(s) 192. The lid 120 may be pivoted into the open position (see FIGS. 4 and 5) before or after the compressible portion(s) 140 are transitioned into the compressed state. Rotating the lid 120 to the open position automatically transitions the spout closure 122 to the closed position, if the spout closure 122 was in the open position.

Next, the unfiltered liquid 204 is poured into the pre-filtered liquid area 182. Then, the user releases the compressible portion(s) 140 allowing the compressible portion(s) 140 to return the uncompressed state. As the compressible portion(s) 140 transition to the uncompressed state, the volume of the filtered liquid storage area 180 increases, which pulls the unfiltered liquid 204 through the filter holder 118 (e.g., through the through-hole(s) 244 illustrated in FIGS. 17 and 18), the filter member 116, the through-hole(s) 184 (see FIGS. 10-12) of the lower closed portion 150, and into the filtered liquid storage area 180.

In other words, as the compressible portion(s) 140 returns to the uncompressed state, an air pressure inside the filtered liquid storage area 180 is less than an air pressure inside the pre-filtered liquid area 180. Thus, suction is temporarily created in the filtered liquid storage area 180 with respect to the pre-filtered liquid area 180 as the compressible portion(s) 140 returns to the uncompressed state. This suction pulls or sucks the unfiltered liquid 204 downwardly from the pre-filtered liquid area 180 through the filter member 116 and into the filtered liquid storage area 180. The suction also pulls the flap 114 downwardly against the spout portion 190 and plugs the through-hole(s) 192 (see FIGS. 11 and 12).

The compression and release of the compressible portion(s) 140 may be repeated until the filtered liquid storage area 180 is completely full.

The filtered liquid 206 may be poured from the filtered liquid storage area 180 by tipping the pitcher 100. The filtered liquid 206 pushes the flap 114 outwardly as the filtered liquid 206 flows through the through-hole(s) 192 (see FIGS. 11 and 12). The filtered liquid 206 may also push the spout closure 122 into the open position (see FIG. 6) as the filtered liquid 206 flows out through the upper open portion 132 (see FIGS. 4, 5, and 7-9) in the spout area 186. Alternatively, before the filtered liquid 206 is poured from the filtered liquid storage area 180, the spout closure 122 may be rotated to the open position, which automatically transitions the lid 120 to the closed position, if the lid 120 was in the open position. However, the lid 120 may be rotated to the closed position before the spout closure 122 is rotated to the open position.

### Drinking Vessel

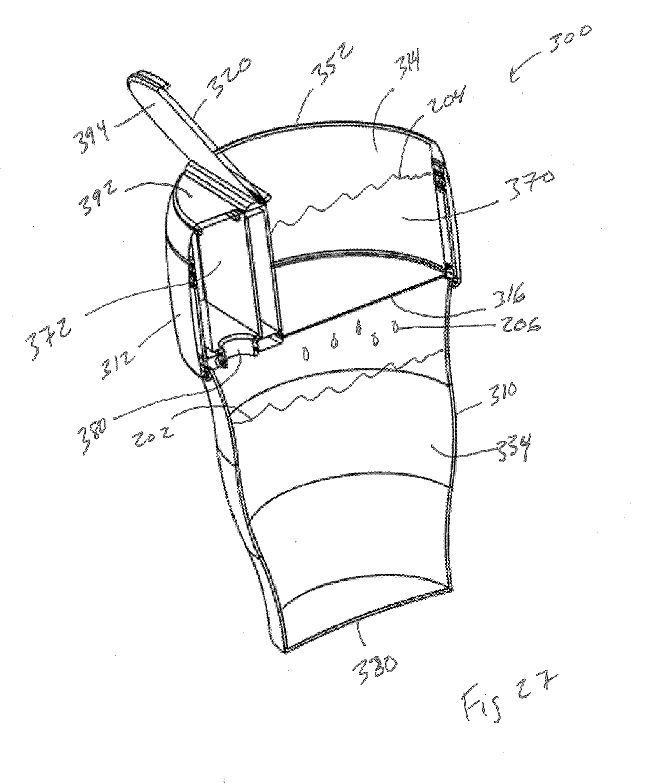

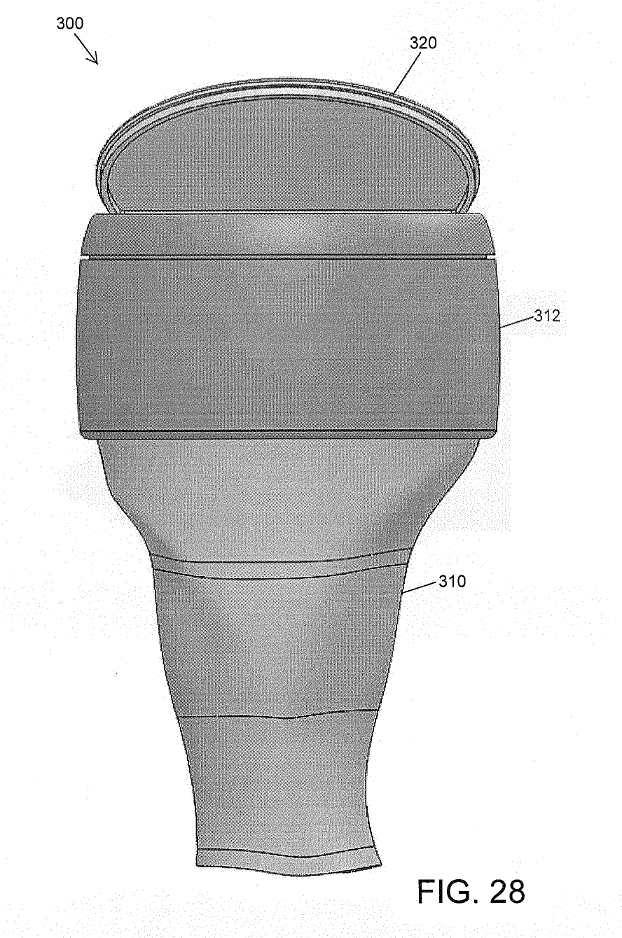

FIGS. 25 and 26 are perspective views of a drinking vessel 300 and FIG. 27 is a cross-sectional view of the drinking vessel 300. Referring to FIG. 27, the drinking vessel 300 includes a compressible body portion 310, an outer housing 312, an inner housing 314, a filter member 316, and a lid 320.

### Compressible Body Portion

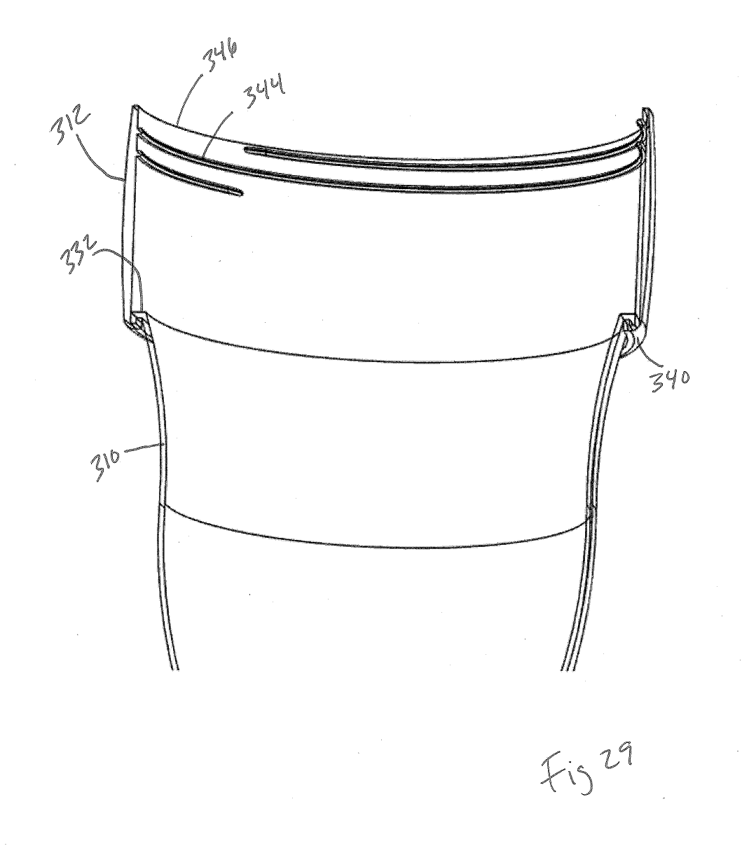

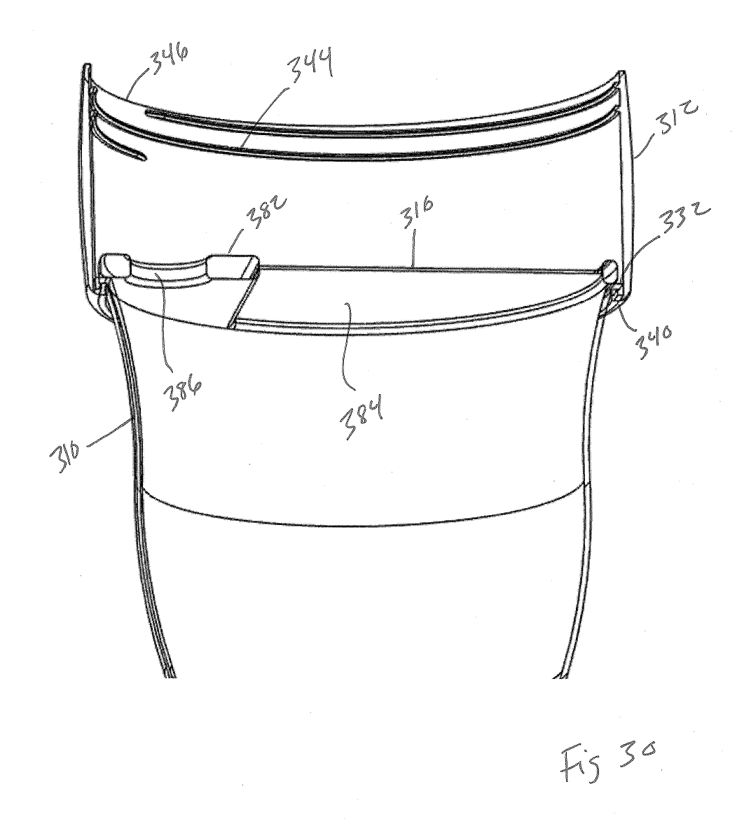

Referring to FIG. 27, the compressible body portion 310 may be generally cup shaped. Thus, the compressible body portion 310 includes a lower closed portion 330 opposite an upper open portion 332 (see FIGS. 29 and 30) and defines a filtered liquid storage area 334. The compressible body portion 310 may be transitioned between an uncompressed state (see FIG. 25-27) and a compressed state (see FIG. 28). The compressible body portion 310 is configured to be compressed manually by a user to transition the compressible body portion 310 from the uncompressed state to the compressed state. In the compressed state, a volume of the filtered liquid storage area 334 is reduced. Reducing the volume forces air from inside the filtered liquid storage area 334. By way of a non-limiting example, the compressible body portion 310 may be constructed from silicone or similar deformable material.

### Outer Housing

Referring to FIG. 29, the outer housing 312 is configured to be attached to the upper open portion 332 of the compressible body portion 310. For example, the upper open portion 332 may be received inside an open lower portion 340 of the outer housing 312. The upper open portion 332 may form an interference or friction fit with the open lower portion 340 of the outer housing 312. In the embodiment illustrated, the upper open portion 332 curls outwardly and downwardly. The open lower portion 340 curls inwardly and upwardly. Thus, the curled open lower portion 340 engages and interlocks with the curled upper open portion 332. The outer housing 312 includes inside threads 344. Referring to FIG. 30, the filter member 316 is configured to rest upon the upper open portion 332 of the compressible body portion 310 inside the outer housing 312. In the embodiment illustrated, the outer housing 312 is generally cylindrically shaped and has an open upper portion 346 opposite the open lower portion 340.

### Inner Housing

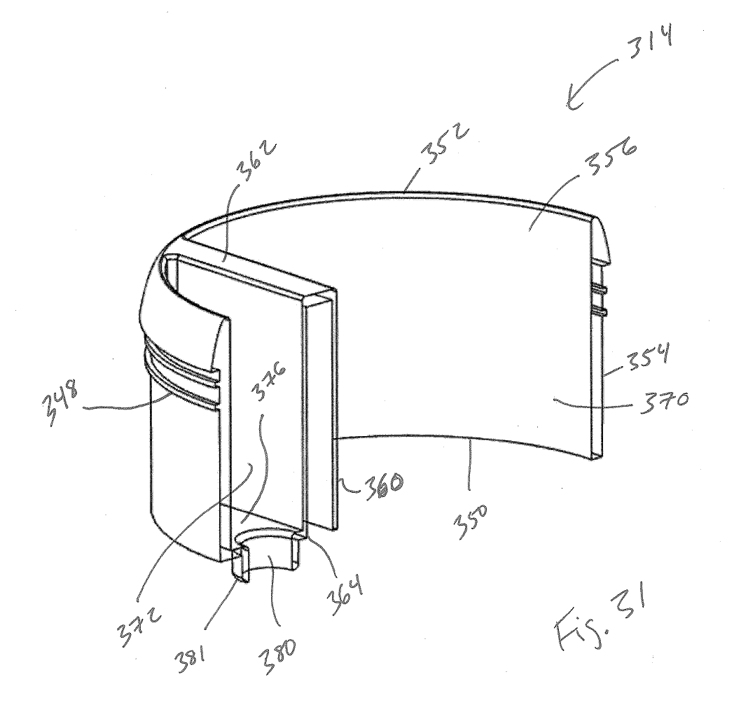

Referring to FIG. 31, the inner housing 314 is configured to received inside the open upper portion 346 (see FIGS. 29 and 30) of the outer housing 312. In the embodiment illustrated, the inner housing 314 has outside threads 348 configured to thread into the inside threads 344 (see FIGS. 29 and 30) of the outer housing 312 (see FIGS. 25-30). Referring to FIG. 27, the filter member 316 may be positioned or sandwiched in between the inner housing 314 and the upper open portion 332 (see FIGS. 29 and 30) of the compressible body portion 310.

In the embodiment illustrated, the inner housing 314 is generally cylindrically shaped. The inner housing 314 includes lower and upper open portions 350 and 352. A sidewall 354 extends between the lower and upper open portions 350 and 352 and defines an internal area 356. A divider 360 divides the internal area 356 into a pre-filter area 370 and a drinking area 372. While identified as being the drinking area 372, the drinking area 372 may be characterized as being a spout area or a pouring area because the filtered liquid 206 exits the drinking vessel 300 by being poured through the drinking area 372. The divider 360 has an upper portion 362 opposite a lower portion 364.

In the drinking area 372, a transverse portion 376 connects the lower portion 364 of the divider 360 with the sidewall 354 along the lower open portion 350. The transverse portion 376 includes one or more through-holes 380 that interconnect the drinking area 372 and the filtered liquid storage area 334 (see FIG. 27). In the embodiment illustrated, each of the through-holes 380 is surrounded by a sidewall 381 that extends downwardly from the transverse portion 376.

### Filter Member

Referring to FIG. 30, as mentioned above, the filter member 316 is configured to be positioned between the upper open portion 332 of the compressible body portion 310 and the lower open portion 350 of the inner housing 314. In the embodiment illustrated, the filter member 316 is generally disk shaped. However, this is not a requirement.

The filter member 316 may be substantially similar to the filter member 116 (see Figures) and may be constructed from any material(s) suitable for constructing the filter member 116. The filter member 316 may include a seal 382 positioned about a periphery of one or more filter material(s) 384. The filter material(s) 384 may be constructed from any material(s) suitable for constructing the filter material(s) 230.

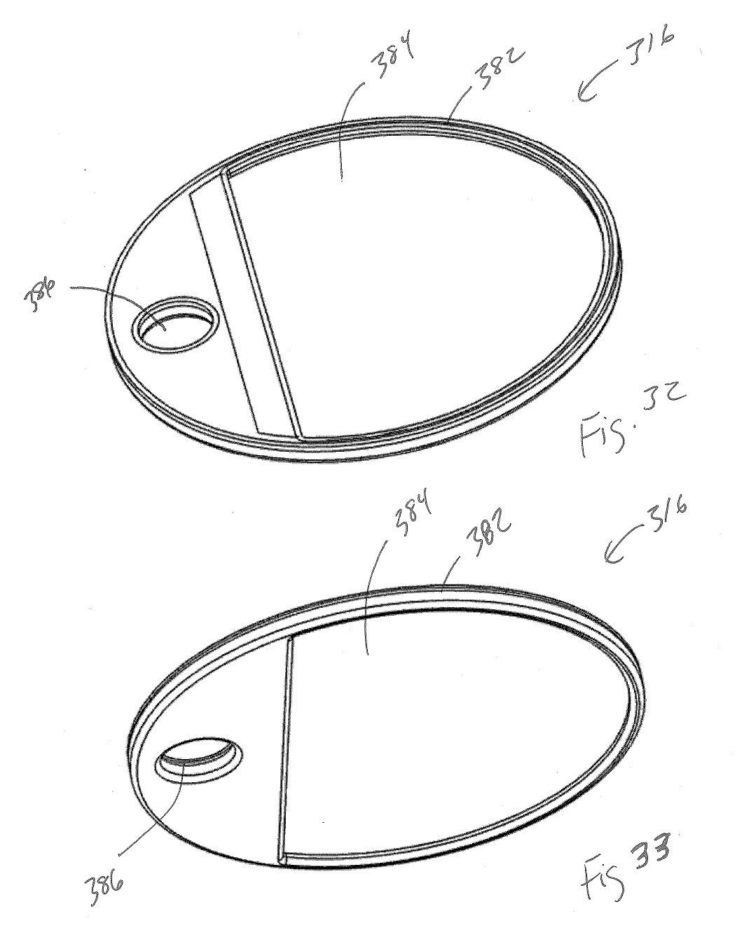

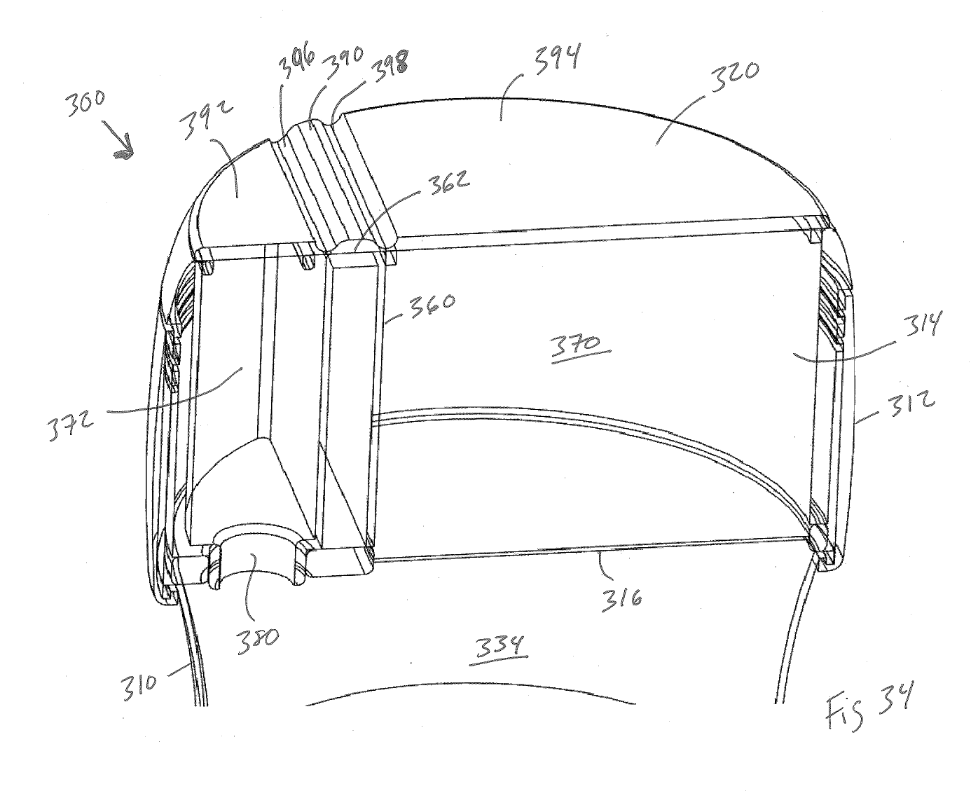

Referring to FIG. 27, the seal 382 (see FIGS. 32 and 33) is configured to prevent the unfiltered liquid 204 from flowing around (instead of through) the filter material(s) 384. The seal 382 may include a different through-hole 386 (see FIGS. 30, 32, and 33) configured to receive the sidewall 381 surrounding each of the through-hole(s) 380. Thus, the through-hole(s) 386 is/are aligned with the through-hole(s) 380, which allows the filtered liquid 206 to flow therethrough.

The seal 382 may be constructed from any material(s) suitable for constructing the seal 232. The seal 232 is configured to be compressed by the inner housing 314 against the upper open portion 332 (see FIGS. 29 and 30) of the compressible body portion 310.

### Lid

Referring to FIG. 34, the lid 320 has an anchor portion 390 that separates a drinking cover 392 from a storage cover 394. The anchor portion 390 is configured to be attached to the upper portion 362 of the divider 360. A first hinge 396 separates the drinking cover 392 and the anchor portion 390. A second hinge 398 separates the storage cover 394 and the anchor portion 390.

The drinking cover 392 is rotatable about the first hinge 396 between a closed position (see FIGS. 25, 27, and 34) and an open position (see FIG. 26). When the drinking cover 392 is in the closed position, the drinking area 372 is sealed from the outside environment and air cannot enter the drinking area 372 through the upper open portion 352. When the drinking cover 392 is in the open position, the filtered liquid 206 (see FIG. 27) may flow from the filtered liquid storage area 334 through the through-hole(s) 380 and into the drinking area 372. The user may drink the filtered liquid 206 (see FIG. 27) through the upper open portion 352 (see FIGS. 27 and 31) along the drinking area 372.

The storage cover 394 is rotatable about the second hinge 398 between a closed position (see FIGS. 26 and 34) and an open position (see FIGS. 25, 27, and 28). Optionally, a one-way valve (not shown) may be installed in the storage cover 394 and configured to allow air to flow into the filtered liquid storage area 334 (through the filter member 316) as the filtered liquid 206 is poured from the filtered liquid storage area 334 through the through-hole(s) 380. Alternatively, the storage cover 394 may be opened to allow the air to flow into the filtered liquid storage area 334. The storage cover 394 may be placed in the closed position to help prevent contaminants from entering the drinking vessel 300.

The drinking cover 392 may be configured to automatically transition the storage cover 394 from the open position (see FIGS. 25, 27, and 28) to the closed position (see FIGS. 26 and 34) when the drinking cover 392 is rotated to the open position (see FIG. 26). Similarly, the storage cover 394 may be configured to automatically transition the drinking cover 392 from the open position (see FIG. 26) to the closed position (see FIGS. 25, 27, and 34) when the storage cover 394 is rotated to the open position (see FIGS. 25, 27, and 28). In such embodiments, only the storage cover 394 or the drinking cover 392 may be open at one time, which prevents the unfiltered liquid 204 inside or being poured into the pre-filter area 370 from contaminating the drinking area 372 and/or the filtered liquid 206 via the drinking cover 392. It also prevents the filtered liquid 206 (e.g., when the filtered liquid 206 is being poured from the filtered liquid storage area 334) from entering the pre-filter area 370 via the storage cover 394. By way of non-limiting examples, the lid 320 may be constructed from a stiff plastic or the hinges 396 and 398 may cause the drinking cover 392 to stay shut while the storage cover 394 is open and the pre-filter area 370 is being filled with the unfiltered liquid 204.

### Operation

Referring to FIG. 37, the user fills the drinking vessel 300 by compressing the compressible body portion 310 into the compressed state (see FIG. 28), which forces air from the filtered liquid storage area 334 out through the filter member 316 and/or the through-hole(s) 380. Optionally, the user may place the storage cover 394 in the open position (see FIG. 26) before compressing the compressible body portion 310 to allow the air from the filtered liquid storage area 334 to flow out through the filter member 316 and the upper open portion 352 (see FIGS. 27 and 31) along the pre-filter area 370. Optionally, the user may place the drinking cover 392 in the open position (see FIG. 26) before compressing the compressible body portion 310 to allow the air from the filtered liquid storage area 334 to flow out through the through-hole(s) 380 and the upper open portion 352 (see FIGS. 27 and 31) along the drinking area 372.

The storage cover 394 may be pivoted into the open position before or after the compressible body portion 310 is transitioned into the compressed state. Rotating the storage cover 394 to the open position automatically transitions the drinking cover 392 to the closed position, if the drinking cover 392 was in the open position. Next, the unfiltered liquid 204 is poured into the pre-filter area 370. Then, the user releases the compressible body portion 310 allowing the compressible body portion 310 to return the uncompressed state. As the compressible body portion 310 transitions to the uncompressed state, the volume of the filtered liquid storage area 334 increases, which pulls the unfiltered liquid 204 through the filter member 316 and into the filtered liquid storage area 334. In other words, as the compressible body portion 310 returns to the uncompressed state, an air pressure inside the filtered liquid storage area 334 is less than an air pressure inside the pre-filter area 370. Thus, suction is temporarily created in the filtered liquid storage area 334 with respect to the pre-filter area 370 as the compressible body portion 310 returns to the uncompressed state. This suction pulls or sucks the unfiltered liquid 204 downwardly from the pre-filter area 370 through the filter member 316 and into the filtered liquid storage area 334.

The compression and release of the compressible body portion 310 may be repeated until the filtered liquid storage area 334 is completely full. The filtered liquid 206 may be poured from the filtered liquid storage area 334 by tipping the drinking vessel 300. Before the filtered liquid 206 is poured from the filtered liquid storage area 334, the drinking cover 392 may be rotated to the open position, which automatically transitions the storage cover 394 to the closed position, if the storage cover 394 was in the open position. However, the storage cover 394 may be rotated to the closed position before the drinking cover 392 is rotated to the open position.

The filter member 316 may be replaced by unthreading the inner housing 314 from the outer housing 312, removing the filter member 316, inserting another filter member, and threading the inner housing 314 into the outer housing 312.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components.

Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. A vessel comprising:
a pre-filtered liquid area configured to receive an unfiltered liquid;
a compressible portion defining at least in part a filtered liquid storage area, the compressible portion being configured to be compressed into a compressed state, the compressible portion being configured to return to an uncompressed state when no longer compressed; and
filter material positioned between the pre-filtered liquid area and the filtered liquid storage area, the unfiltered liquid being sucked from the pre-filtered liquid area into the filtered liquid storage area through the filter material when the compressible portion returns to the uncompressed state increasing a volume of the filtered liquid storage area and sucking the unfiltered liquid through the filter material, the filter material filtering the unfiltered liquid as the unfiltered liquid is sucked through the filter material to produce a processed liquid comprising at least one of filtered liquid and purified liquid.

2. The vessel of claim 1, wherein the compressible portion is configured to be compressed manually by a user into the compressed state, and
the compressible portion is configured to return to the uncompressed state when no longer compressed by the user.

3. The vessel of claim 1, wherein the filter material adds a flavoring to the processed liquid as the unfiltered liquid is sucked through the filter material.

4. The vessel of claim 1, wherein the filter material is configured to filter at least one of particulates, pathogens, pharmaceuticals, and other debris from the unfiltered liquid using an electropositive charge.

5. The vessel of claim 1, wherein the filter material is configured to filter submicron particulates from the unfiltered liquid.

6. The vessel of claim 1, wherein the filter material is configured to filter alkalinity from or neutralize alkalinity in the unfiltered liquid.

7. The vessel of claim 1, further comprising:
a body portion comprising the compressible portion, the filtered liquid storage area being positioned inside the body portion; and
an internal housing positioned inside the body portion, the pre-filtered liquid area being inside the internal housing, the internal housing comprising at least one through-hole allowing the unfiltered liquid to be sucked therethrough from the pre-filtered liquid area into the filtered liquid storage area when the unfiltered liquid is sucked through the filter material, the filter material being positioned to filter the unfiltered liquid as the unfiltered liquid is sucked through the at least one through-hole.

8. The vessel of claim 7, wherein the body portion comprises a spout area in fluid communication with the filtered liquid storage area,
the processed liquid is pourable from the filtered liquid storage area through the spout area, and
the spout area is isolated from the pre-filtered liquid area.

9. The vessel of claim 8, wherein the internal housing comprises a spout portion dividing the spout area from the filtered liquid storage area,
the spout portion comprises at least one aperture that connects the spout area with the filtered liquid storage area, and
the vessel further comprising a flap positioned to cover the at least one aperture, the flap being forced into an open position by air exiting the filtered liquid storage area through the at least one aperture when the compressible portion is compressed into the compressed state, the flap returning to a closed position when the air is no longer exiting the filtered liquid storage area through the at least one aperture.

10. The vessel of claim 8, further comprising:
a lid configured to cover the pre-filtered liquid area, the lid being transitionable between an open lid position and a closed lid position, the lid preventing contamination from entering the pre-filtered liquid area when the lid is in the closed lid position; and
a spout closure configured to cover the spout area, the spout closure being transitionable between an open closure position and a closed closure position, the spout closure preventing contamination from entering the spout area when the spout closure is in the closed closure position, the lid automatically transitioning the spout closure to the closed closure position when the spout closure is in the open closure position and the lid is rotated to the open lid position, the spout closure automatically transitioning the lid to the closed lid position when the lid is in the open lid position and the spout closure is rotated to the open closure position.

11. The vessel of claim 7, wherein the filter material is a component of a filter member,
the filter member includes a seal positioned about a periphery of the filter material,
the internal housing comprising a filter area,
the at least one through-hole being positioned in the filter area, and
the vessel comprises a filter holder configured to compress the seal against the filter area of the internal housing.

12. The vessel of claim 11, wherein the filter holder is hingedly attached to the internal housing,
the filter holder is rotatable into an open position allowing the filter member to be removed and replaced, and
the filter holder is rotatable into a closed position whereat the filter holder compresses the seal against the filter area of the internal housing.

13. The vessel of claim 1, wherein the compressible portion is constructed from silicone.

14. The vessel of claim 1, further comprising:
a body portion comprising the compressible portion, the filtered liquid storage area being positioned inside the body portion; and
an inner housing positioned above the body portion, the pre-filtered liquid area being inside the inner housing, the filter material separating the pre-filtered liquid area from the filtered liquid storage area.

15. The vessel of claim 14, wherein the inner housing comprises a drinking area in fluid communication with the filtered liquid storage area,
the drinking area is configured to receive the processed liquid from the filtered liquid storage area, and
the drinking area is isolated from the pre-filtered liquid area.

16. A vessel comprising:
a pre-filtered liquid area configured to receive an unfiltered liquid;
a compressible portion defining at least in part a filtered liquid storage area, compressing the compressible portion into a compressed state and subsequently allowing the compressible portion to return to an uncompressed state temporarily creating suction in the filtered liquid storage area as the compressible portion returns to the uncompressed state;
a conduit between the pre-filtered liquid area and the filtered liquid storage area; and
a filter member positioned to filter the unfiltered liquid as the unfiltered liquid is sucked from the pre-filtered liquid area into the filtered liquid storage area through the conduit by the suction temporarily created in the filtered liquid storage area, the filter member filtering the unfiltered liquid as the unfiltered liquid is sucked through the filter member to produce a processed liquid comprising at least one of filtered liquid and purified liquid.

17. The vessel of claim 16, wherein the compressible portion is configured to be compressed manually by a user into the compressed state, and
the compressible portion is configured to return to the uncompressed state when no longer compressed by the user.

18. The vessel of claim 16, wherein the filter member adds a flavoring to the processed liquid as the unfiltered liquid is sucked through the filter member.

19. The vessel of claim 16, wherein the filter member is configured to filter the unfiltered liquid using an electropositive charge.

20. The vessel of claim 16, further comprising:
a body portion comprising the compressible portion, the filtered liquid storage area being positioned inside the body portion; and
an internal housing positioned inside the body portion, the pre-filtered liquid area being inside the internal housing, the internal housing comprising at least one through-hole allowing the unfiltered liquid to be sucked therethrough from the pre-filtered liquid area into the filtered liquid storage area when the unfiltered liquid is sucked through the filter member, the filter member being positioned to filter the unfiltered liquid as the unfiltered liquid is sucked through the at least one through-hole.

21. The vessel of claim 20, wherein the body portion comprises a pouring area,
the internal housing comprises a divider that divides the pouring area from the filtered liquid storage area and isolates the pouring area from the pre-filtered liquid area,
the divider comprises at least one aperture that connects the pouring area with the filtered liquid storage area,
the vessel further comprising a flap positioned to cover the at least one aperture, the flap being forced into an open position by air exiting the filtered liquid storage area through the at least one aperture when the compressible portion is compressed into the compressed state, the flap returning to a closed position when the air is no longer exiting the filtered liquid storage area through the at least one aperture,
the processed liquid is pourable from the filtered liquid storage area through the at least one aperture and the pouring area, and
the processed liquid forces the flap into the open position when processed liquid is poured from the filtered liquid storage area through the at least one aperture and the pouring area.

22. The vessel of claim 21, further comprising:
a lid configured to cover the pre-filtered liquid area, the lid being transitionable between an open lid position and a closed lid position, the lid preventing contamination from entering the pouring area when the lid is in the closed lid position; and
a closure configured to cover the pouring area, the closure being transitionable between an open closure position and a closed closure position, the closure preventing contamination from entering the pouring area when the closure is in the closed closure position, the lid automatically transitioning the closure to the closed closure position when the closure is in the open closure position and the lid is rotated to the open lid position, the closure automatically transitioning the lid to the closed lid position when the lid is in the open lid position and the closure is rotated to the open closure position.

23. The vessel of claim 20, wherein the filter member includes a seal positioned about a periphery of filter material,
the internal housing comprising a filter area,
the at least one through-hole being positioned in the filter area, and
the vessel comprises a filter holder configured to compress the seal against the filter area of the internal housing.

24. The vessel of claim 23, wherein the filter holder is hingedly attached to the internal housing,
the filter holder is rotatable into an open position allowing the filter member to be removed and replaced, and
the filter holder is rotatable into a closed position whereat the filter holder compresses the seal against the filter area of the internal housing.

25. A vessel comprising:
a compressible portion defining at least in part a filtered liquid storage area, compressing the compressible portion into a compressed state and subsequently allowing the compressible portion to return to an uncompressed state temporarily creating suction in the filtered liquid storage area as the compressible portion returns to the uncompressed state;
a pre-filtered liquid area positioned above the filtered liquid storage area, the pre-filtered liquid area being configured to receive an unfiltered liquid; and
a filter member separating the pre-filtered liquid area from the filtered liquid storage area, the filter member allowing the unfiltered liquid to be sucked therethrough by the suction temporarily created in the filtered liquid storage area, the filter member filtering the unfiltered liquid as the unfiltered liquid is sucked through the filter member to produce a processed liquid comprising at least one of filtered liquid and purified liquid.

26. The vessel of claim 25, further comprising:
a body portion comprising the compressible portion, the filtered liquid storage area being positioned inside the body portion; and
an inner housing positioned above the body portion, the pre-filtered liquid area being inside the inner housing, the inner housing comprising a drinking area in fluid communication with the filtered liquid storage area, the drinking area being configured to receive the processed liquid from the filtered liquid storage area, the drinking area being isolated from the pre-filtered liquid area.

27. The vessel of claim 25, wherein the compressible portion is configured to be compressed manually by a user into the compressed state, and
the compressible portion is configured to return to the uncompressed state when no longer compressed by the user.
